(19) United States
(12) Patent Application Publication
(10) Pub. No.: US 2016/0071444 A1
(43) Pub. Date: Mar. 10, 2016

(54) MULTI-UTILITY MODULAR FLAG HOLDING DEVICE

(71) Applicant: STEPHEN AKWASI AGYEI, BRONX, NY (US)

(72) Inventor: STEPHEN AKWASI AGYEI, BRONX, NY (US)

(21) Appl. No.: 14/940,154

(22) Filed: Nov. 13, 2015

(51) Int. Cl. G09F 17/00

(52) U.S. Cl. CPC G09F 17/00; G09F 2017/0066

(57) ABSTRACT

The various embodiments herein provide a multi-utility modular flag holding device comprising a telescopic base and a carrying case. The telescopic base further comprises a telescopic arm, a primary switch, a flag pole and a flashlight. The telescopic arm comprises a plurality of multi-height coaxially fitted small arms. The plurality of small arms protrude in a sequential manner to form a large flag holding arm. The primary switch attached to the telescopic arm and controls a protrusion of the plurality of small arms. The flag pole is connected to a first end of the telescopic arm through a hinge. The flashlight is housed in a second end of the telescopic arm. An operation of the flashlight is controlled by a secondary switch connected to the telescopic arm. The carrying case houses the telescopic base and comprises shoulder strap.

### BACKGROUND

1. Technical Field of Invention

The embodiments herein generally relate to a portable flag and particularly relate to a multi-utility modular flag holding device. The embodiments herein more particularly relate to a readily hostable flag post with modular assembly and enhancement for route guidance.

2. Description of Related Art

Now a days a flag porting has become common at gathering places like during a sports or support to a political party or a national independence or any occurrence of a national pride moment. The conventional flags are mostly big and bulky in nature, so waving them becoming becomes a tough and sometimes leads to casualties or fights. Mostly during games where live spectators desire to show their moral boosting support to their team, try to waves large flags in harder way which causes non-visibility for other and sometimes due to its bulky nature, the flags hit few spectators.

One of the prior arts discloses a portable flag holding pole having a flag tube a holder, rising and setting groove to facilitate the rising and setting of a flag into an inner tube, a cap, a slope gear and a slope gear projection positioned at the inner part of the cap, a projection piece of the slope gear for insertion into a cutting groove, an axial pin connected to the slope gear projection, a revolving body flexibly mounted at an end of the winding inner tube through which an insert driving shaft is inwardly passed and a spring is mounted flexibly. A cutting groove engages a fixed pin of the revolving body with the insert holding piece positioned at the rear end of the insert driving shaft inserted into the insert holding piece of a supporting means. The supporting means is fixed to a pressure holding part, or into an insert supporting piece groove of a cutting flexible piece which forms a cutting window at the middle portion of the flag tube and holder. The portable flag holding pole may also include a rising and setting flexibly fixed projection in the winding inner tube characterized in that a grooved jaw and a slope jaw are provided in the injection part of the outer tube of the flag holder for hoisting and carrying, and a projection jaw, a projection rising and setting hole at the rear end of the rising and setting tube, and an arch projection attached to the two ends of an extended spring for flexing (bending) and flexibly supporting the pole.

Another prior art discloses a process and a device for dividing a tubular flagpole that comprises introducing into the flagpole an elongated body, which over at least part of its length has a geometric shape, which in concert with a complementary geometric shape inside the flagpole ensures that the flagpole can be cut and assembled in a way that guarantees the rectilinear continuity of the flagpole. The complementary geometric shape is formed in that, after the body is introduced into the flagpole, a filling material is injected so that the space between the flagpole and the elongated body is filled. The flagpole is then cut around the elongated body down to the outer surface of the body so that the geometric shape allows the flagpole to be divided into two sections at the cutting side, the body remaining fixed to one of the sections.

Yet another prior art discloses a flagpole and ferrule assembly for mounting in a golf cup hole is disclosed. The flagpole and ferrule both include cooperating coupling parts to form an attachment between the flagpole and the ferrule. A cap is applied over portions of the flagpole and the ferrule to couple to the retaining members and secure the flagpole to the ferrule.

Yet another prior arts discloses an expandable safety flag stowed in a pouch attached to a flotation vest. The pouch includes an opening leading to an interior of the pouch. When not in use, the safety flag is stowed within the interior of pouch. When desired, the safety flag is removed from the pouch and expanded to a larger size. The user can then wave the flag to attract the attention of others.

However, the conventional portable flag poles and assemblies are limited in their utility. Further the conventional flag poles and assemblies are stringent in nature i.e. the conventional portable flag poles does not allow a user opt-ability to show their support by waving the flag without hindering the nearby spectators' view. Also the conventional portable flag poles or assemblies fail to allow a real time change of flag due to their complex assembly design.

In the view of foregoing, there is a need for a portable multi-utility modular flag device for raising a flag. Also there is a need for a modular flag holding device with a least complex assembly to allow a real change of flag or adjust a length of the flag.

The above mentioned shortcomings, disadvantages and problems are addressed herein, as detailed below.

### SUMMARY OF THE INVENTION

The primary object of the embodiments herein is to provide a portable multi-utility modular flag device for raising a flag.

Another object of the embodiments herein is to provide a modular flag holding device with a least complex assembly to allow a real change of flag or adjust a length of the flag.

The various embodiments herein provide a multi-utility modular flag holding device comprising a telescopic base and a carrying case. The telescopic base further comprises a telescopic arm, a primary switch, a flag pole and a flashlight. The telescopic arm comprises a plurality of multi-height coaxially fitted small arms. The plurality of small arms protrude in a sequential manner to form a large flag holding arm. The primary switch attached to the telescopic arm and controls a protrusion of the plurality of small arms. The flag pole is connected to a first end of the telescopic arm through a hinge. The flashlight is housed in a second end of the telescopic arm. An operation of the flashlight is controlled by a secondary switch connected to the telescopic arm. The carrying case houses the telescopic base and comprises shoulder strap.

According to one embodiment herein, the flag pole is moveable at multi-degree freedom through the hinge in a vertical direction. The multi-degree freedom comprises a range from 0-90°.

According to one embodiment herein, the flag pole is moveable at multi-degree freedom through the hinge in a horizontal direction. The multi-degree freedom comprises a range from 0-360°.

According to one embodiment herein, the telescopic arm is selectively protrudeable to a height range of 0.5-10 feet.

According to one embodiment herein, the telescopic arm is made up of a polymerised hardened plastic material.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a protruded view of the multi-utility flag holding device, according to one embodiment herein.

FIG. 2 illustrates a contracted view of the multi-utility flag holding device, according to one embodiment herein.

FIG. 3 illustrates a carrying case for the multi-utility flag holding device, according to one embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a multi-utility modular flag holding device comprising a telescopic base and a carrying case. The telescopic base further comprises a telescopic arm, a primary switch, a flag pole and a flashlight. The telescopic arm comprises a plurality of multi-height coaxially fitted small arms. The plurality of small arms protrude in a sequential manner to form a large flag holding arm. The primary switch attached to the telescopic arm and controls a protrusion of the plurality of small arms. The flag pole is connected to a first end of the telescopic arm through a hinge. The flashlight is housed in a second end of the telescopic arm. An operation of the flashlight is controlled by a secondary switch connected to the telescopic arm. The carrying case houses the telescopic base and comprises shoulder strap.

According to one embodiment herein, the flag pole is moveable at multi-degree freedom through the hinge in a vertical direction. The multi-degree freedom comprises a range from 0-90°.

According to one embodiment herein, the flag pole is moveable at multi-degree freedom through the hinge in a horizontal direction. The multi-degree freedom comprises a range from 0-360°.

According to one embodiment herein, the telescopic arm is selectively protrudeable to a height range of 0.5-10 feet.

According to one embodiment herein, the telescopic arm is made up of a polymerised hardened plastic material.

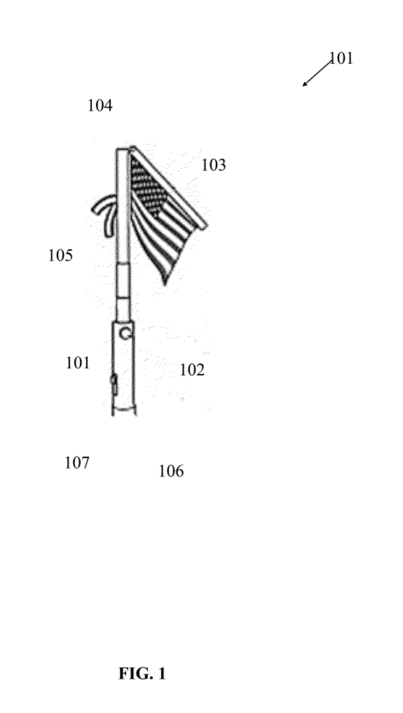

FIG. 1 illustrates a protruded or opened state view of the multi-utility flag holding device, according to one embodiment herein. With respect to FIG. 1, the flag holding device 100 comprises a telescopic arm 101 with a plurality of protruding small arms. The plurality of small arms are hollow in nature and lie coaxially inside each other. On pressing the primary switch 102 provided on the telescopic arm 101, the smaller arms with larger diameter protrudes to a predetermined limits followed by sequential protrusion of small arms with lower diameter. For raising a flag, the flag is attached to the flag pole 103 which is further attached to a first end the telescopic arm 101 through a hinge 104 primarily in an orthogonal manner. The flag pole 103 has varied angular degree of freedom in a vertical and horizontal direction. In a non-functional condition, the flag pole 103 is folded vertical to a parallel level with respect to the telescopic arm 101 and held to the folded position through straps 105. A second end of the telescopic arm 101 is attached with the flashlight 106 whose “On/OFF” operation is controlled by a secondary switch 107 connected to the telescopic arm 101.

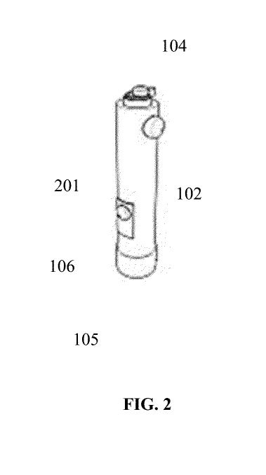

FIG. 2 illustrates a contracted or closed state view of the multi-utility flag holding device, according to one embodiment herein. With respect to FIG. 2, in a contracted position, the plurality of small arms lies coaxially at a single place inside a telescopic arm base 201 with the hinge 104 at the first end. The telescopic arm base 201 is a small arm with largest diameter. The telescopic arm base 201 is attached with the primary switch 102 and secondary switch 106 and also houses the flashlight 105.

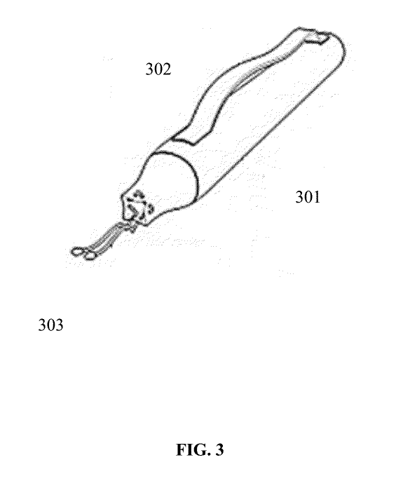

FIG. 3 illustrates a carrying case for the multi-utility flag holding device, according to one embodiment herein. With respect to FIG. 3, the carrying case 301 is primarily made up of an elastic polymer with a shoulder strap 302 at its outer surface. The carrying case 301 also comprises a tie string 303 on one end to close an opening of the carrying case 301 for safely holding the flag device.

The present flag holding device provide a safe carriage and use during a flag waving moment. The flag holding device also allows a user to adjust angle of the flag in order to avoid any discomfort to nearby spectator. The flag holding device has applicability in various area of gathering due to its wide range of adjustable height. Since the flag holding device has no sharp edges, thus eradicates any harm to the user or nearby spectator. Due to a lightweight assembly, the flag holding device is easy to carry and use in different circumstances. Also, the flashlight provision in the same hosing of the flag holding device provides a multi-utility edge to the user while roaming in dark places or in place of gathering with low visibility or poor lighting conditions.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A multi-utility modular flag holding device comprising:
a telescopic base, wherein the telescopic base further comprises:
a telescopic arm, wherein the telescopic arm comprises a plurality of multi-height coaxially fitted small arms, wherein the plurality of small arms protrude in a sequential manner to form a large flag holding arm;
a primary switch, wherein the primary switch attached to the telescopic arm and controls a protrusion of the plurality of small arms;
a flag pole, wherein the flag pole is connected to a first end of the telescopic arm through a hinge;
a flashlight, wherein the flashlight is housed in a second end of the telescopic arm, wherein an operation of the flashlight is controlled by a secondary switch connected to the telescopic arm;
a carrying case, wherein the carrying case houses the telescopic base and comprises shoulder strap.

2. The flag holding device according to claim 1, wherein the flag pole is moveable at multi-degree freedom through the hinge in a vertical direction, wherein the multi-degree freedom comprises a range from 0-90°.

3. The flag holding device according to claim 1, wherein the flag pole is moveable at multi-degree freedom through the hinge in a horizontal direction, wherein the multi-degree freedom comprises a range from 0-360°.

4. The flag holding device according to claim 1, wherein the telescopic arm is selectively protrude-able to a height range of 0.5-10 feet.

5. The flag holding device according to claim 1, wherein the telescopic arm is made up of a polymerised hardened plastic material.
